(19) United States
(12) Patent Application Publication
(10) Pub. No.: US 2026/0316924 A1
(43) Pub. Date: Oct. 15, 2026

(54) Short Takeoff and Landing Aircraft

(71) Applicant: Textron Aviation Inc., Wichita, KS (US)

(72) Inventors: Gonzalo Eduardo Mendoza, Wichita, KS (US); Corey Wailes Hagemeister, Wichita, KS (US); Steven Michael Klausmeyer, Wichita, KS (US)

(21) Appl. No.: 19/177,445

(22) Filed: Apr. 11, 2025

(51) Int. Cl. B64C 25/34; B64C 1/14; B64C 1/22; B64C 25/10

(52) U.S. Cl. CPC B64C 25/34; B64C 1/1415; B64C 1/22; B64C 25/10

(57) ABSTRACT

A short takeoff and landing aircraft having a forward wing and an aft wing attached to a top side of a fuselage. Propulsion engines are mounted within the aft section of the fuselage while an auxiliary turboshaft compressor is installed in between the forward and aft wings substantially above or to the side opposite a cargo door configured to provide access to a cargo area within the fuselage. The turboshaft compressor provides airflow to force circulation around the wing and flight surfaces, increasing their lifting capabilities at low speeds.

### BACKGROUND

### 1. Field

Embodiments of the invention relate generally to aircraft, and more specifically to jet powered aircraft capable of short takeoff and landing (STOL) for transporting cargo.

### 2. Description of the Related Art

Short takeoff and landing aircraft are known and aircraft designed for carrying cargo are also known. For instance, U.S. patent application Ser. No. 18/483,338 to Mendoza et al. discloses an electric aircraft designed for carrying cargo, the disclosure of which is herein incorporated by reference.

International Patent Publication No. WO 2019/232472 to Bevirt et al. discloses an aerial vehicle with fixed wings adapted with propulsion assemblies for both vertical takeoff and landing (VTOL) and for forward flight. International Patent Publication No. WO 2018/217667 to Karem et al. discloses an electric VTOL aircraft with a fuselage configured to carry payload, passengers, and landing gear. The aircraft is configurable to accommodate different numbers of passengers and cargo space with an optional ramp for loading payloads. U.S. Patent Application Publication No. 2020/0115045 to Mermoz et al. discloses an electrically or hybrid powered multirotor aircraft. The multirotor aircraft includes a fuselage configured to transport passengers or goods and two fixed wings.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1A is a perspective view of an embodiment of a STOL aircraft;

FIG. 1B is a perspective view of another embodiment of a STOL aircraft;

FIG. 2A is a side view of the STOL aircraft of FIG. 1A;

FIG. 2B is a side view of the STOL aircraft of FIG. 1B;

FIG. 3A is a front view of the STOL aircraft of FIG. 1A;

FIG. 3B is a front view of the STOL aircraft of FIG. 1B;

FIG. 4A is a front partially internal view of the STOL aircraft of FIG. 1A;

FIG. 4B is a front partially internal view of the STOL aircraft of FIG. 1B;

FIG. 5A is a perspective, partially internal view of the STOL aircraft of FIG. 1A;

FIG. 5B is a perspective, partially internal view of the STOL aircraft of FIG. 1B;

FIG. 6A is a top view of the STOL aircraft of FIG. 1A;

FIG. 6B is a top view of the STOL aircraft of FIG. 1B;

FIG. 7A is a front view of a passenger seating arrangement, in an embodiment, for the STOL aircraft of FIG. 1A;

FIG. 7B is a front view of a passenger seating arrangement, in an embodiment, for the STOL aircraft of FIG. 1B;

FIG. 8 is a perspective view of another embodiment of a STOL aircraft

FIG. 9A is a perspective view of the STOL aircraft of FIG. 1A having winglets turned upwards;

FIG. 9B is a perspective view of the STOL aircraft of FIG. 1B having winglets turned upwards;

FIG. 10A is a perspective view of the STOL aircraft of FIG. 1A having winglets turned downwards; and

FIG. 10B is a perspective view of the STOL aircraft of FIG. 1B having winglets turned downwards.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

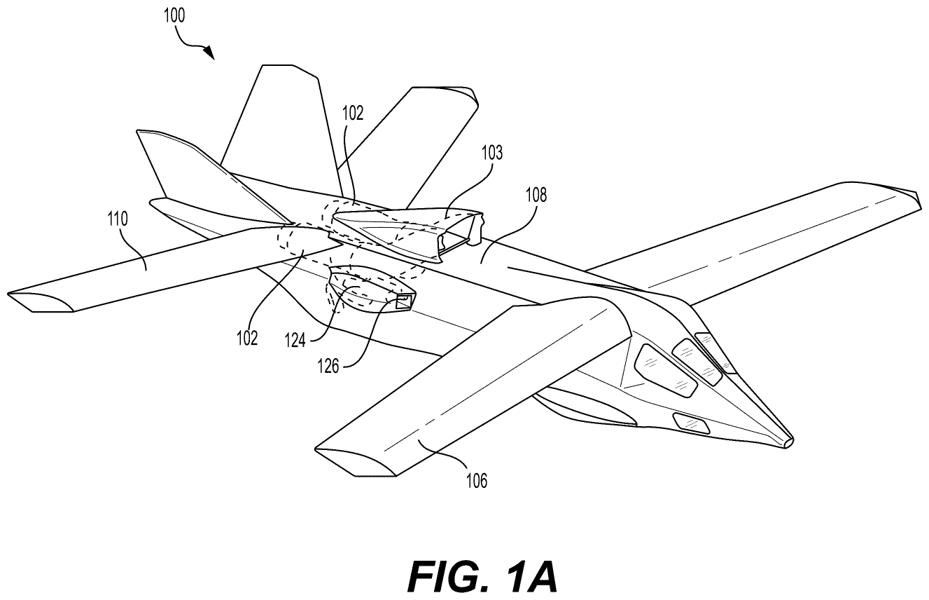

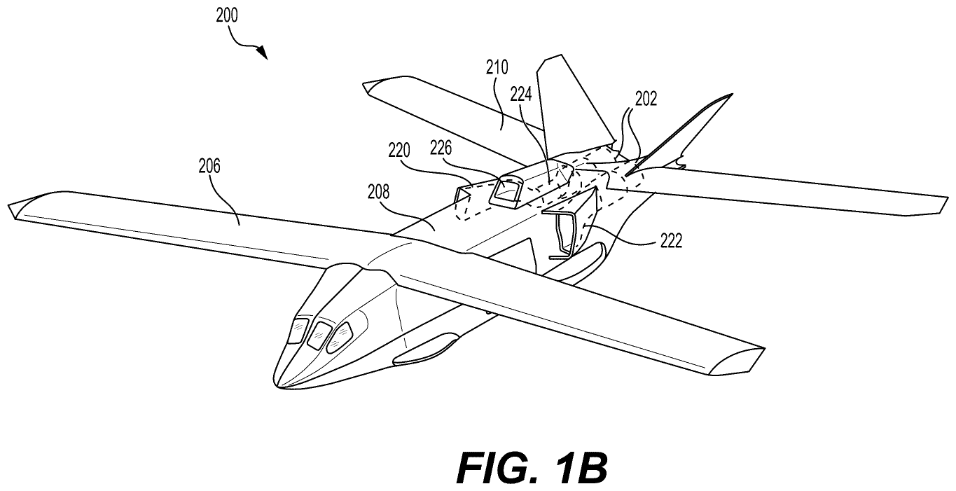

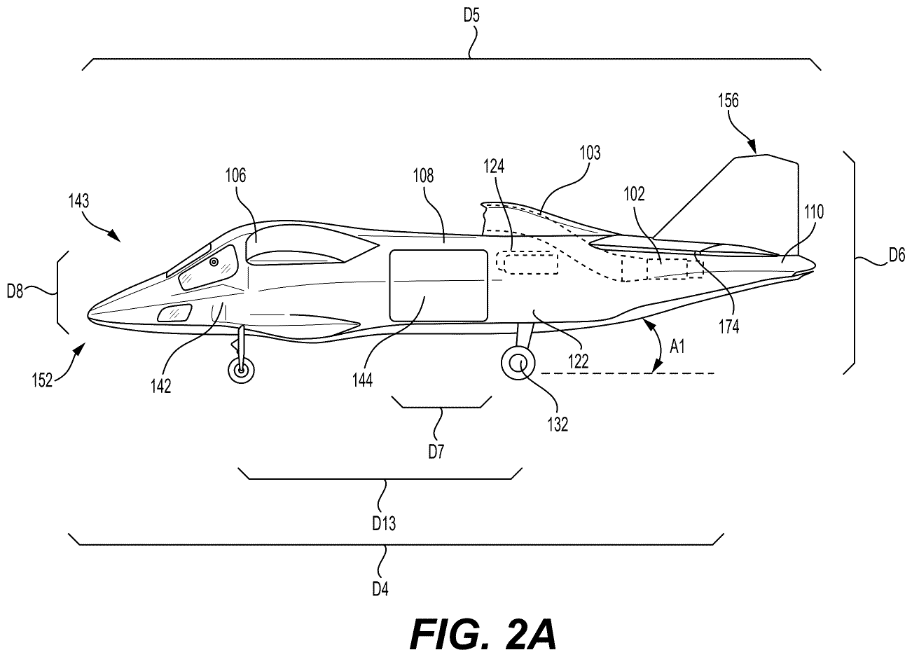

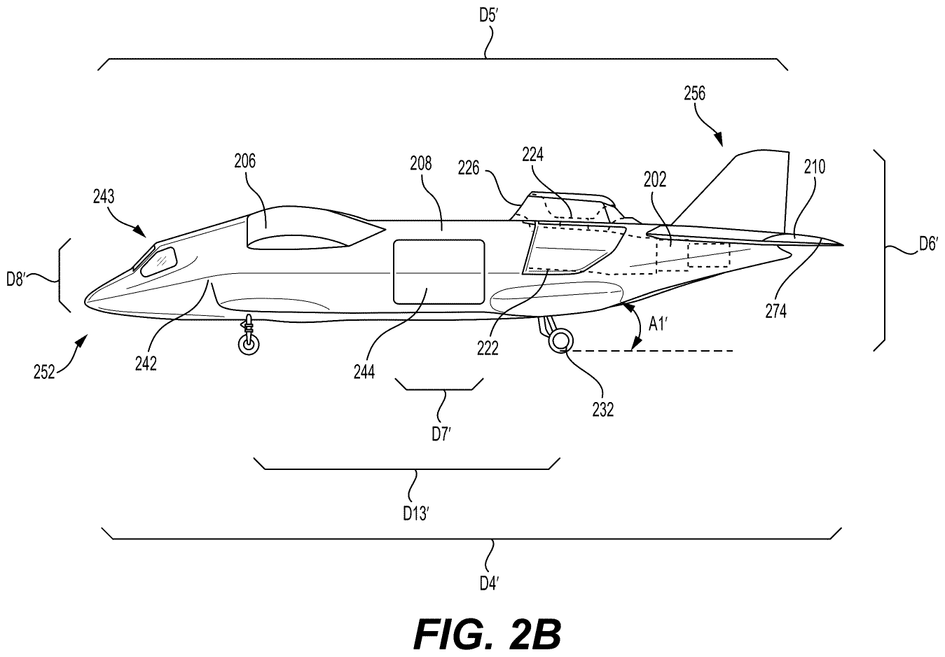

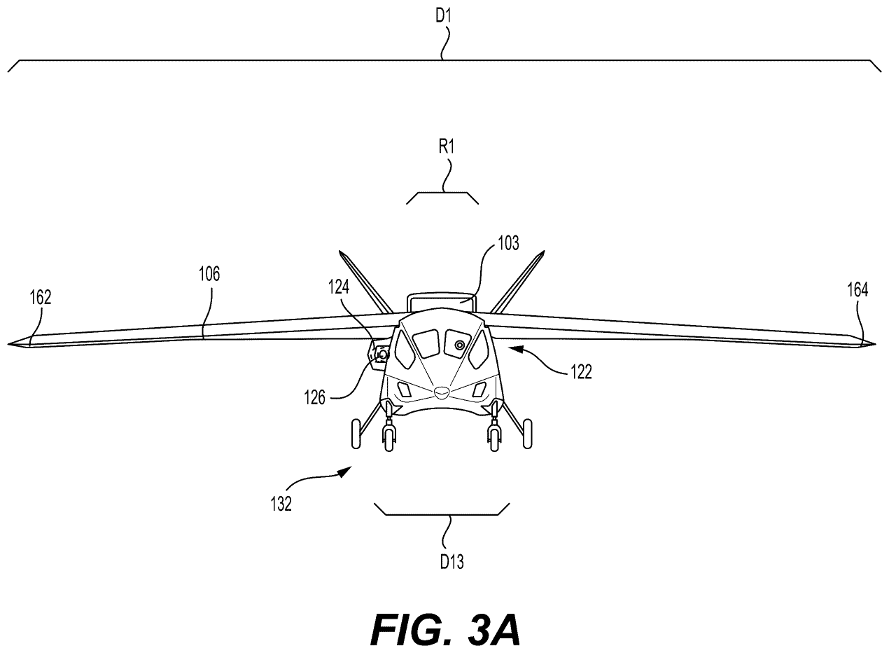

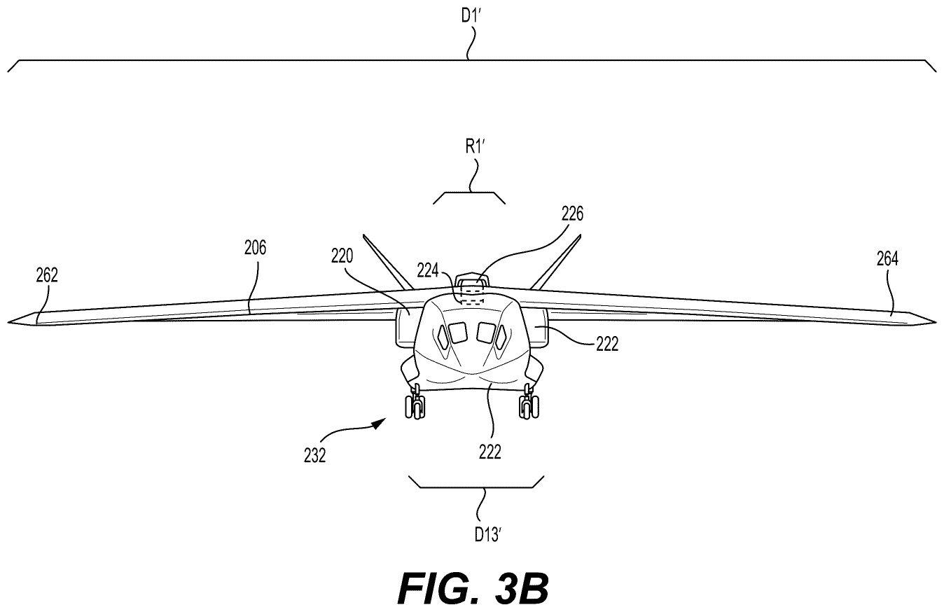

FIGS. 1A and 1B are perspective views of a first configuration and a second configuration of exemplary short takeoff and landing (STOL) aircraft 100 and 200. FIGS. 2A and 2B are side views of STOL aircraft 100 and 200. FIGS. 3A and 3B are front views of STOL aircraft 100 and 200. FIGS. 1A-3B are best viewed together with the following description. In embodiments, with reference to FIG. 1A, STOL aircraft 100 includes a double jet propulsion engine 102, and, with reference to FIG. 1B, STOL aircraft 200 includes a double jet propulsion engine 202. STOL aircraft 100 includes a forward wing 106 positioned forward on a top side of fuselage 108 and an aft wing 110 positioned aft on the top side of fuselage 108. Double propulsion engine 102 is mounted within a tail cone of the fuselage 108 substantially beneath aft wing 110. STOL aircraft 200 includes a forward wing 206 positioned forward on a top side of fuselage 208 and an aft wing 210 positioned aft on the top side of fuselage 108. Double propulsion engine 202 is mounted within the tail cone portion of fuselage 208 substantially beneath aft wing 210. Mounting the double jet propulsion engines 102 and 202 in the tail cone portion of fuselage 108 and 208 can substantially reduce the engine's observability. The double jet propulsion engine 102 and 202 are configured as fixed-orientation engines that remain in the forward-facing position (i.e., the engines are not tiltable). The engines 102 are configured with intake 103 disposed on a top portion of the fuselage 108 just forward of aft wings 110. The engines 202 are configured with intakes 220/222 disposed on the sides of the fuselage 208 just forward of aft wings 110. In some embodiments, the forward sweep of the forward wings 106 and 206, the intakes 103/220/222, and partially internal propulsion engines 102 and 202 may reduce the observability of the aircraft by reducing the underbite of the engine exhaust and angular profile of the sides and top of fuselage 108/208. In some embodiments, the STOL aircraft 100/200 may be covered in a radar absorbent coating which may reduce the radar signature of the aircraft.

In embodiments, the propulsion engines 102 and 202 may comprise one or more turbofans configured with the intakes 103 and 220/222, respectively.

With reference to FIG. 2A, STOL aircraft 100 includes a nose section 152 at a forward end of fuselage 108 and tail section 156 at an aft end of the main fuselage 108. A bottom side of the aft wing 110 is angled downwardly from the fuselage 108, whereas opposing portions of the tail section 156 extend at an angle upwards from the top side of the fuselage 108. Aft wing 110 extends laterally from tail section 156, substantially near the bottom side of tail section 156 as shown in FIG. 2A.

With reference to FIG. 2B, STOL aircraft 200 includes a nose section 252 at a forward end of fuselage 208 and tail section 256 at an aft end of the main fuselage 208. A bottom side of the aft wing 210 is angled downwardly from the fuselage 208, whereas opposing portions of the tail section 256 extend at an angle upwards from the top side of the fuselage 208. Aft wing 210 extends laterally from tail section 256, substantially near the bottom side of tail section 256 as shown in FIG. 2A.

In some embodiments, forward wings 106 and 206 may extend substantially from a top portion of fuselage 108 and 208 as shown in FIGS. 2A and 2B. As best viewed in FIGS. 1A and 1B, forward wings 106 and 206 and aft wings 110 and 210 may comprise a slight anhedral (e.g., downward) angle such that the wing tips are lower than the aircraft fuselage 108. In other embodiments, forward wings 106 and 206 and aft wings 110 and 210 may comprise a slight dihedral (e.g., upward) angle such that the wing tips are higher than the aircraft fuselage 108. The dihedral or anhedral angle of the wings may depend on the desired trade between lateral stability, manufacturing simplicity, and radar low-observability targets. In some embodiments, positioning of the wings onto the top portion of fuselage 108/208 may make the STOL aircraft 100/200 less susceptible to ground objects, dirt, and rocks. In some embodiments the upper placement of forward wings 106/206 may allow the fuselage 108/208 to be positioned closer to the ground which may be advantageous for accessing the aircraft. High-mounted wings may also allow for substantially simplified (e.g., gravity fed) fuel systems.

In some embodiments, as best viewed in FIGS. 2A and 2B, forward wings 106 and 206 comprise a straight (i.e., unswept) leading edge and a tapered trailing edge such that forward wings 106 and 206 are narrower at a tip of the wing. In other embodiments (not shown), forward wings 106 and 206 comprise a slightly forward-swept leading edge. Forward and aft sweep of forward wings 106 and 206 can adjust the aerodynamic center of the aircraft for adequate longitudinal stability and also tailor the front or rear radar observability of the aircraft.

Aft wings 110 and 210 each comprise a swept wing, in embodiments, in which both the leading edge and the trailing edge of the wings are swept aftwards. In some embodiments, the straight leading edge of forward wings 106/206 and the swept, aft wings 110/210 may be advantageous for aerodynamics of the aircraft 100/200. For instance, the unswept leading edge of tapered wings 106/206 may be conducive to high lift capability which is advantageous for low speed flight phases such as takeoff and landing. The increased low speed lifting capability of substantially straight leading edge tapered wing 106/206 may thus result in better runway performance or allow for an overall smaller wing footprint, reducing mass and drag and therefore improving cruise characteristics. The forward swept trailing edge of tapered wing 106/206 may also provide increased clearance for side cargo door access. The aft swept wings 110/210 also contribute towards unobstructed access to the side cargo door while allowing for favorable positioning of the aerodynamic center of the aircraft. The sweep in aft wings 110/210 may also be advantageous in high angle of attack conditions.

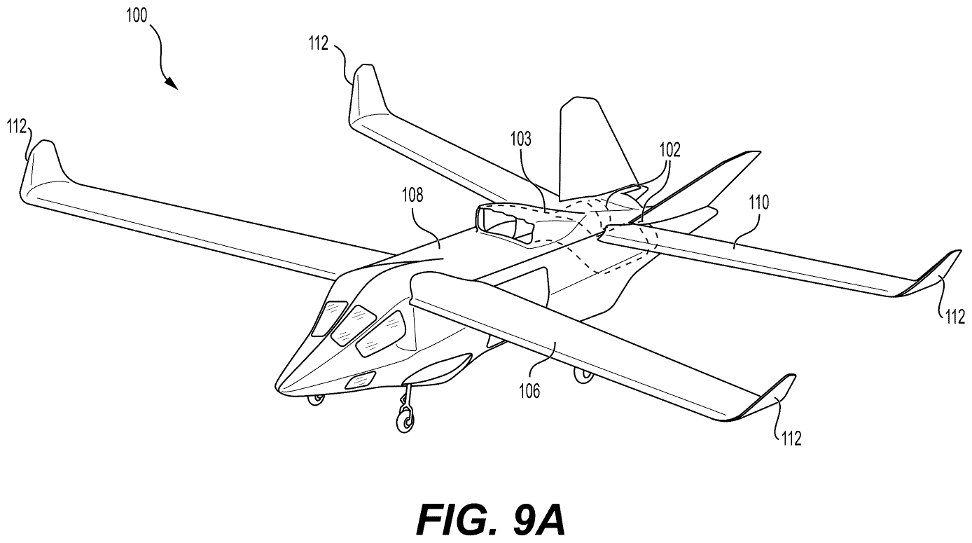

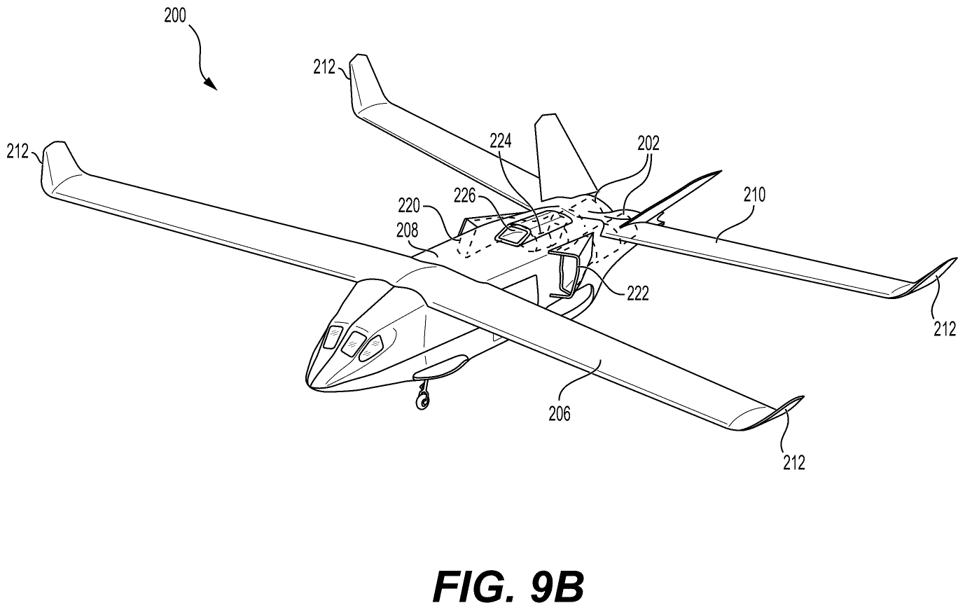

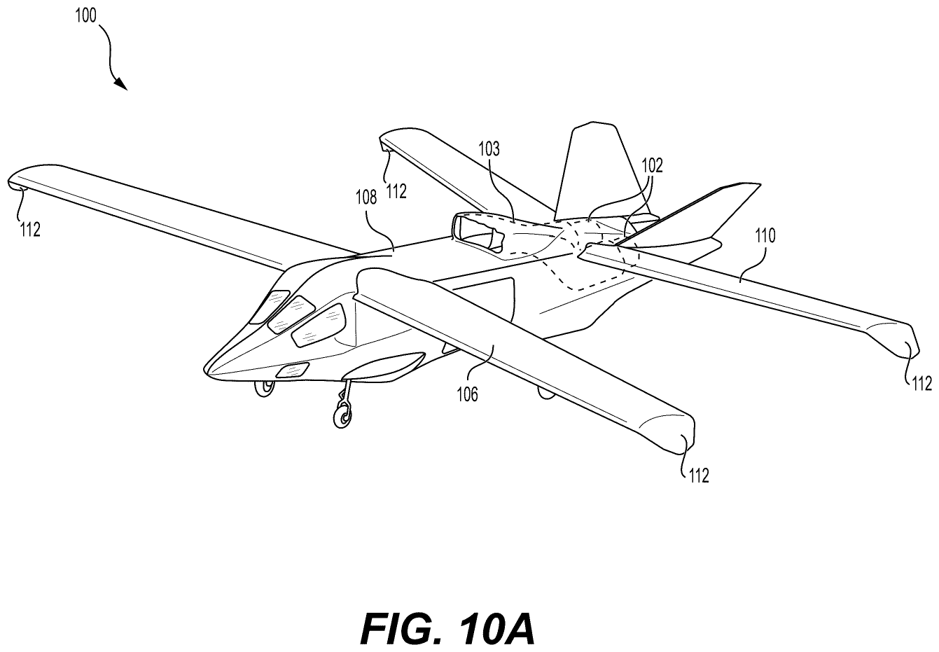

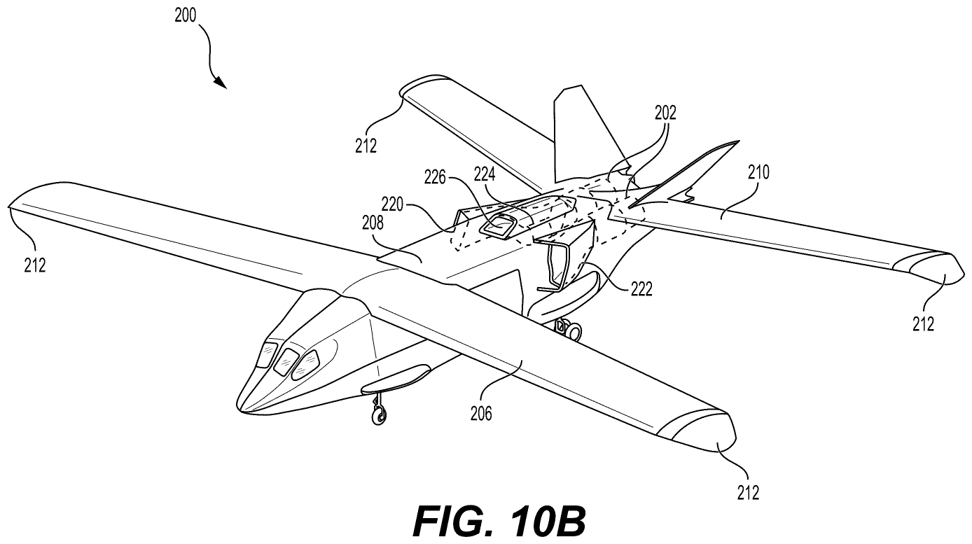

In some embodiments with reference to FIGS. 9A-10B, wings 106/206 and 110/210 may be equipped with winglets 112/212 to increase span loading efficiency. More specifically, with reference to FIGS. 9A and 10A, wings 106 and 110 include winglets 112, and, with reference to FIGS. 9B and 10B wings 206/210 include winglets 212. Wings 110/210 may be equipped with winglets 112/212 to increase directional stability. In some embodiments the increase in directional stability afforded by winglets 112/212 in wings 110/210 may be used to reduce the size of the tail fins. In some embodiments, the winglets 112/212 may be turned upwards (see FIGS. 9A and 9B), and in some embodiments, the winglets 112/212 may be turned downwards (see FIGS. 10A and 10B) to reduce the observability of a winglet equipped aircraft 100/200.

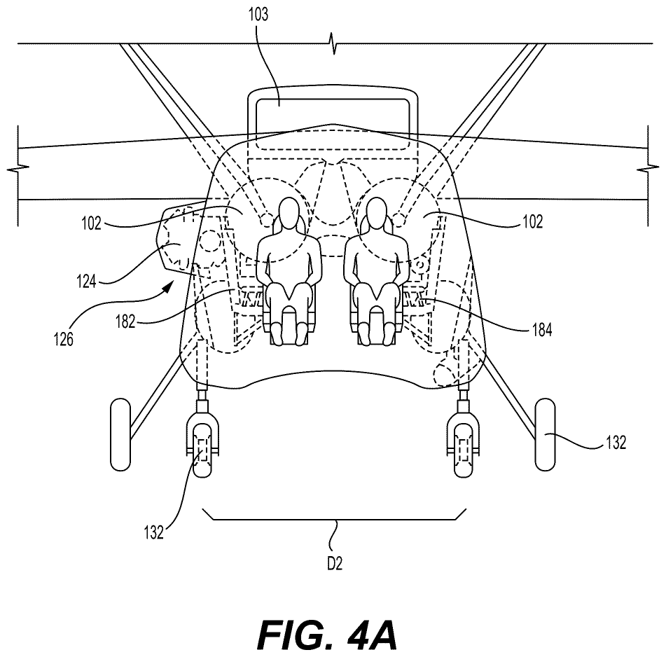

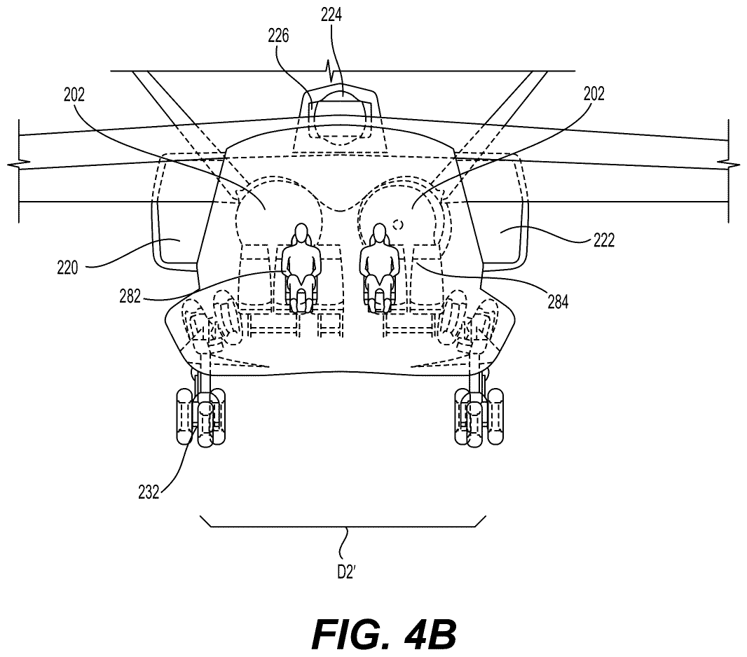

In some embodiments, as best viewed in FIG. 4A, retractable landing gear 132 includes four wheels with two forward wheels positioned towards a nose of the aircraft and two rear wheels located towards an aft end of fuselage 108. In embodiments, the two front wheels of retractable landing gear 132 are positioned further inboard towards the center of fuselage 108 than the two rear wheels. In embodiments, the forward wheels may each be attached to a separate leg and the rear wheels may each be attached to a separate leg. Referring to FIG. 2A, a cockpit door 142 is located generally near the cockpit 143 and provides access to the cockpit 143. A cargo door 144 provides a large and unobstructed entryway configured for loading and unloading cargo in and out of fuselage 108. The cargo door 144 is unobstructed from the forward wing 106 by being located aft of the forward wing; the cargo door 144 is unobstructed from the aft wing 110 by being located forward of the aft wing, and the cargo door 144 is unobstructed from the retractable landing gear 132 by being located in between the forward and rear wheels of the landing gear. A main, internal section of the fuselage 108 includes a cargo area configured for receiving cargo, including cargo containers or pallets.

In some embodiments, as best viewed in FIG. 4B, retractable landing gear 232 includes four wheels with two forward wheels positioned towards a nose of the aircraft and two rear wheels located towards an aft end of fuselage 208. In embodiments, the two front wheels and two rear wheels of retractable landing gear 232 are positioned at approximately the same distance outboard from the center of fuselage 208. Referring to FIG. 2B, a cockpit door 242 is located generally near the cockpit 243 and provides access to the cockpit 243. A cargo door 244 provides a large and unobstructed entryway configured for loading and unloading cargo in and out of fuselage 208. The cargo door 244 is unobstructed from the forward wing 206 by being located aft of the forward wing; the cargo door 244 is unobstructed from the retractable landing gear 232 by being located forward of the retractable landing gear 232, and the cargo door 244 is unobstructed from the retractable landing gear 232 by being located in between the forward and rear wheels of the landing gear. A main, internal section of the fuselage 208 includes a cargo area configured for receiving cargo, including cargo containers or pallets.

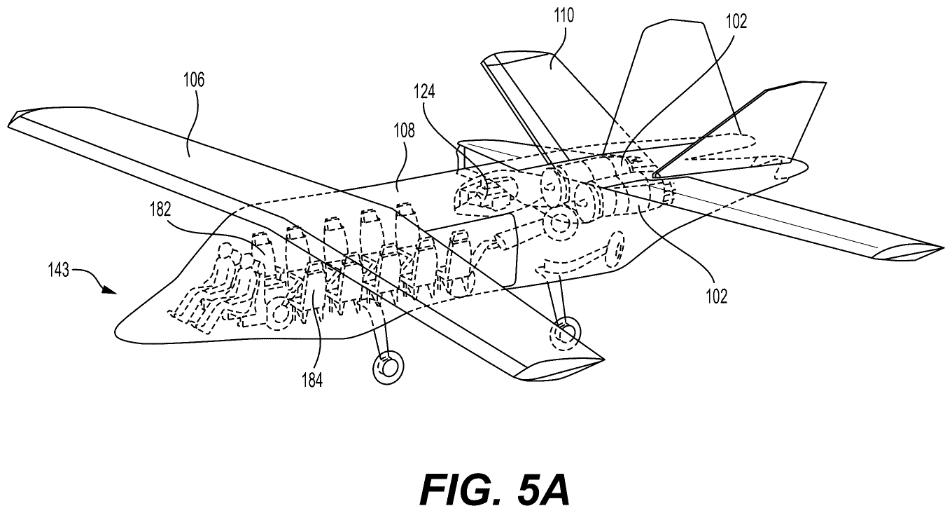

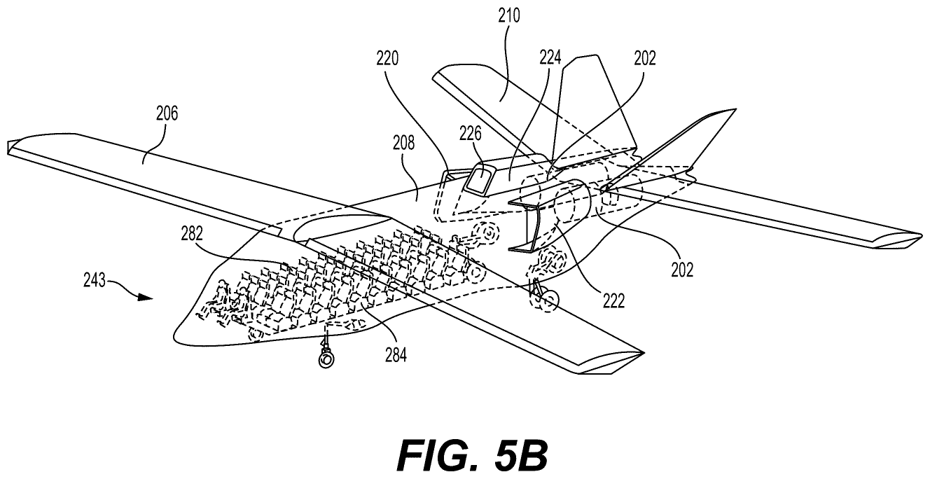

FIGS. 5A and 5B are perspective views of an exemplary STOL aircraft 100 and STOL aircraft 200. STOL aircraft 100 and 200 are configured for passenger seating 182, 184, 282, and 284, combined with cargo loading to provide a hybrid passenger/cargo configuration. FIGS. 5A and 5B are perspective views with see-through portions to enable viewing of internal components.

As shown in FIG. 5A, a first row of seats 182 is located behind a cockpit 143. A second row of seats 184 is located opposite the first row of seats 182. Each row of seats 182, 184 may include one or more seats.

As shown in FIG. 5B, a first row of seats 282 is located behind a cockpit 243. A second row of seats 284 is located opposite the first row of seats 282. Each row of seats 282, 284 may include one or more seats.

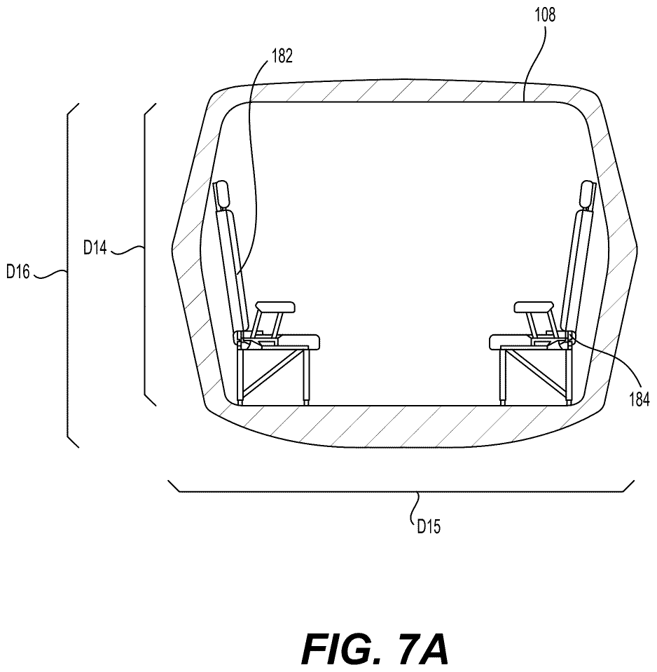

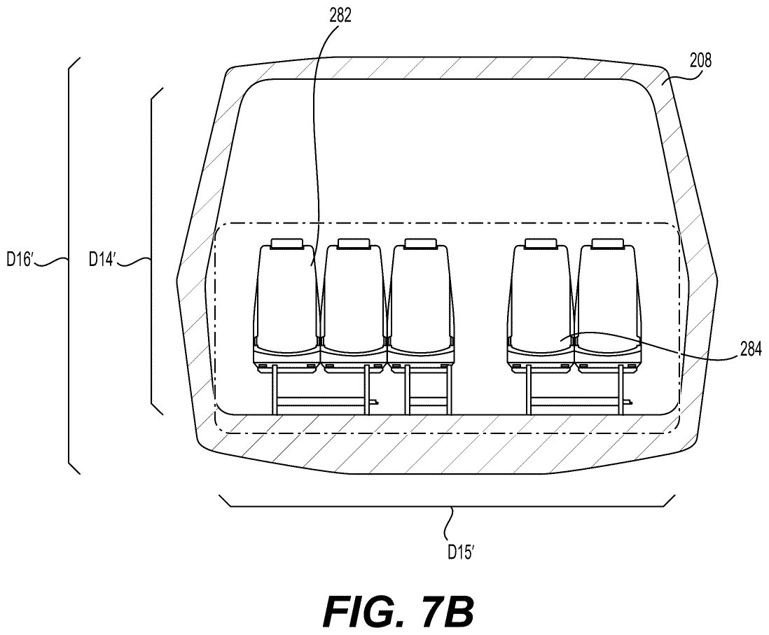

With reference to FIG. 7A the seats 182 and 184 face towards each other, and in FIG. 7B, the seats 282 and 284 are configured to face forward with a row of three seats on the left-hand side of the fuselage 208 and a row of two seats on the right-hand side.

STOL aircraft 200 includes a double propulsion engine 202 and the STOL aircraft 100 includes a double propulsion engine 102. For both STOL aircraft 100 and 200, the double propulsion engine comprises two turbofan engines. The intake 103 is disposed on a top portion of fuselage 108 just forward of aft wing 110, and the turboshaft compressor 124 is configured on a side of the fuselage 108 with an intake 126. In embodiments, the intakes 220 and 222 for engines 202 are positioned on the sides of fuselage 208 and the turboshaft compressor 224 and intake 226 is configured on the top of fuselage 208 just forward of aft wing 210. The turboshaft compressor 124/224 and intakes 126/226 provide compressed air for lift augmentation. Each of the propulsion engines 102/202 has a radius which is the distance from the center of the fan blades to the outermost tip of each nacelle enclosing the fan blades. A first radius R1, depicted in FIG. 3A, is a nacelle radius of aft engine 102. In embodiments, R1 is about 6-inches to about 46-inches. In some embodiments, R1 is about 16-inches to about 36-inches. In certain embodiments, R1 is about 23-inches to about 29-inches. A first radius R1′, depicted in FIG. 3B, is a nacelle radius of aft engine 202. In embodiments, R1′ is about 30-inches to about 70-inches. In some embodiments, R1′ is about 40-inches to about 60-inches. In certain embodiments, R1′ is about 47-inches to about 53-inches.

With reference to FIGS. 1A and 3A, the primary propulsion intake 103 is located on top of the fuselage, just upstream of the aft wing. The intake 103 provides air for a double propulsion engine 102. A turboshaft compressor 124 is located on a side of aft fuselage 108 with an intake 126. The turboshaft compressors 124 provides compressed air for active flow control over control surfaces and lifting surfaces thus increasing maximum lift and providing control authority at low speeds. This substantially allows for STOL aircraft 100 to takeoff in short distances. In some embodiments, the intake 126 immediately ahead of the turboshaft compressor 124 can be actuated in flight to reduce or prevent high speed flow from entering the turboshaft during high speed cruise.

With reference to FIGS. 1B and 3B, dual intakes 220 and 222 are configured on the sides of fuselage 208. The intakes 220, 222 provide air to the primary propulsive engines 202 embedded within the fuselage 208. Intake 226 provides air for a turboshaft compressor 224 disposed on the top of fuselage 208. The turboshaft compressor 224 provides compressed air for active flow control over control surfaces and lifting surfaces thus increasing maximum lift and providing control authority at low speeds. This allows for STOL aircraft 200 to takeoff in substantially short distances. In some embodiments, the intake 226 immediately ahead of the turboshaft compressor 224 can be actuated in flight to reduce or prevent high speed flow from entering the turboshaft during high speed cruise.

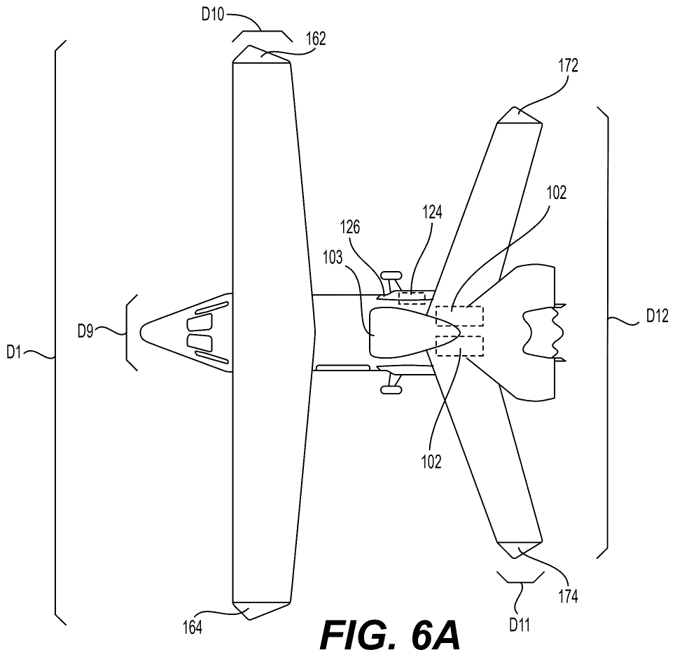

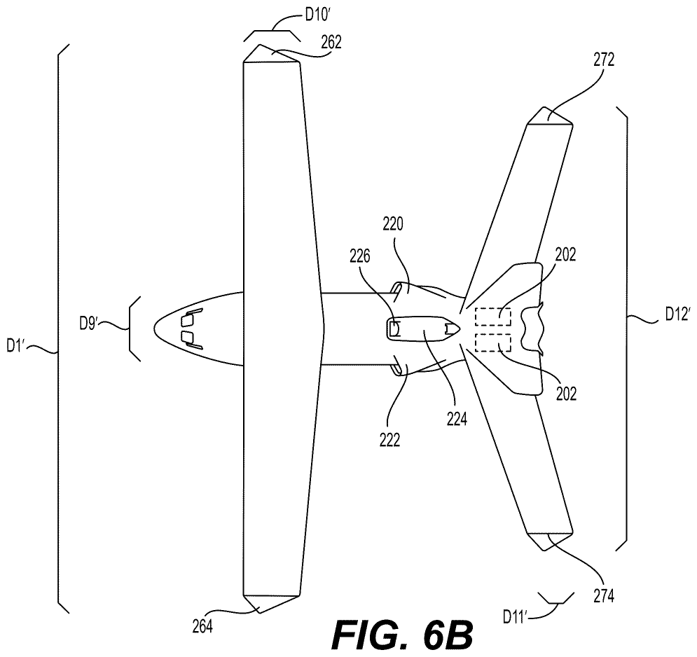

As shown in FIGS. 3A and 6A, a first distance D1 is a maximum lateral (e.g., spanwise) distance between the outermost wing tips 162, 164 of forward wing 106. In embodiments, D1 is about 640-inches to about 680-inches. In some embodiments, D1 is about 650-inches to about 670-inches. In certain embodiments, D1 is about 655-inches to about 665-inches. A second distance D2, with reference to FIG. 4A is a distance between wheels of retractable landing gear 132 when the wheels are deployed. For example, D2 may be a center-to-center distance between the center of each wheel of retractable landing gear 132. In embodiments, D2 is about 120-inches to about 160-inches. In some embodiments, D2 is about 130-inches to about 150-inches. In certain embodiments, D2 is about 135-inches to about 145-inches.

As shown in FIGS. 3B and 6B, a first distance D1′ is a maximum lateral (e.g., spanwise) distance between the outermost wing tips 262, 264 of forward wing 206. In embodiments, D1′ is about 1175-inches to about 1215-inches. In some embodiments, D1′ is about 1185-inches to about 1205-inches. In certain embodiments, D1′ is about 1190-inches to about 1200-inches. A second distance D2′, with reference to FIG. 4B is a distance between wheels of retractable landing gear 232 when the wheels are deployed. For example, D2′ may be a center-to-center distance between the center of each wheel of retractable landing gear 232. In embodiments, D2′ is about 130-inches to about 170-inches. In some embodiments, D2 is about 140-inches to about 160-inches. In certain embodiments, D2′ is about 145-inches to about 155-inches.

With reference to FIG. 2A, a fourth distance D4 is a maximum longitudinal distance from a forwardmost tip of nose section 152 to the aftmost tip of the wing ends 172, 174 of STOL aircraft 100. In embodiments, D4 is about 400-inches to about 600-inches. In some embodiments, D4 is about 450-inches to about 550-inches. In certain embodiments, D4 is about 483-inches to about 489-inches. A fifth distance D5 is a longitudinal distance from a forwardmost tip of nose section 152 to the aftmost tip of tail section 156. In embodiments, D5 is about 400-inches to about 600-inches. In some embodiments, D5 is about 450-inches to about 550-inches. In certain embodiments, D5 is about 483-inches to about 489-inches. In the FIG. 5A embodiment, D5 is greater than D4; however, the wing ends 172, 174 may be reduced in size such that D5 is equal to or smaller than D4 (see FIG. 4B).

With reference to FIG. 2B, a fourth distance D4′ is a maximum longitudinal distance from a forwardmost tip of nose section 252 to the aftmost tip of the wing ends 272, 274 of STOL aircraft 200. In embodiments, D4′ is about 780-inches to about 980-inches. In some embodiments, D4′ is about 830-inches to about 930-inches. In certain embodiments, D4′ is about 878-inches to about 884-inches. A fifth distance D5′ is a longitudinal distance from a forwardmost tip of nose section 252 to the aftmost tip of tail section 256. In embodiments, D5′ is about 700-inches to about 900-inches. In some embodiments, D5′ is about 750-inches to about 850-inches. In certain embodiments, D5′ is about 815-inches to about 821-inches. In the FIG. 5B embodiment, D5′ is less than D4′; however, the wing ends 272, 274 may be reduced in size such that D5′ is equal to or greater than D4′ (see FIG. 4A).

With reference to FIG. 2A, a sixth distance D6 is a maximum height of STOL aircraft 100, extending in the vertical direction from the ground (when retractable landing gear 132 is deployed) to an uppermost tip of the tail section 156. In embodiments, D6 is about 120-inches to about 150-inches. In some embodiments, D6 is about 135-inches to about 155-inches. In certain embodiments, D6 is about 144-inches to about 150-inches.

With reference to FIG. 2B, a sixth distance D6′ is a maximum height of STOL aircraft 200, extending in the vertical direction from the ground (when retractable landing gear 232 is deployed) to an uppermost tip of the tail section 256. In embodiments, D6′ is about 200-inches to about 250-inches. In some embodiments, D6′ is about 215-inches to about 240-inches. In certain embodiments, D6 is about 230-inches to about 236-inches.

With reference to FIG. 2A, a seventh distance D7 is a width of cargo door 144. In embodiments, D7 is about 45-inches to about 85-inches. In some embodiments, D7 is about 55-inches to about 75-inches. In certain embodiments, D7 is about 62-inches to about 68-inches. An eighth distance D8 is a height of the cargo door 144 in the vertical direction. In embodiments, D8 is about 40-inches to about 60-inches. In some embodiments, D8 is about 45-inches to about 55-inches. In certain embodiments, D8 is about 48-inches to about 52-inches.

With reference to FIG. 2B, a seventh distance D7′ is a width of cargo door 244. In embodiments, D7′ is about 90-inches to about 130-inches. In some embodiments, D7 is about 100-inches to about 120-inches. In certain embodiments, D7′ is about 104-inches to about 110-inches. An eighth distance D8′ is a height of the cargo door 244 in the vertical direction. In embodiments, D8′ is about 55-inches to about 95-inches. In some embodiments, D8 is about 65-inches to about 85-inches. In certain embodiments, D8′ is about 71-inches to about 77-inches.

A first angle A1 is the angle between the bottom of retractable landing gear 132 (when deployed) and the aft end of tail section 156, as depicted in FIG. 2A. In embodiments, A1 is about 10-degrees to about 30-degrees. In some embodiments, A1 is about 13-degrees to about 23-degrees. In certain embodiments, A1 is about 15-degrees to about 21-degrees.

A first angle A1′ is the angle between the bottom of retractable landing gear 232 (when deployed) and the aft end of tail section 256, as depicted in FIG. 2B. In embodiments, A1′ is about 10-degrees to about 30-degrees. In some embodiments, A1′ is about 15-degrees to about 25-degrees. In certain embodiments, A1′ is about 17-degrees to about 23-degrees.

As shown in the FIG. 6A embodiment, a ninth distance D9 is a width of the fuselage 108 in the lateral direction. In embodiments, D9 is about 70-inches to about 100-inches. In some embodiments, D9 is about 80-inches to about 90-inches. In certain embodiments, D9 is about 82-inches to about 87-inches. As shown in the FIG. 7A embodiment, a sixteenth distance D16 is the exterior height of the fuselage 108 in the vertical direction. In embodiments, D16 is about 50-inches to about 80-inches. In some embodiments, D16 is about 62-inches to about 72-inches. In certain embodiments, D16 is about 64-inches to about 70-inches.

As shown in the FIG. 6B embodiment, a ninth distance D9′ is a width of the fuselage 208 in the lateral direction. In embodiments, D9′ is about 130-inches to about 170-inches. In some embodiments, D9′ is about 140-inches to about 160-inches. In certain embodiments, D9′ is about 147-inches to about 153-inches. As shown in the FIG. 7B embodiment, a sixteenth distance D16′ is a height of the fuselage 208 in the vertical direction. In embodiments, D16′ is about 90-inches to about 140-inches. In some embodiments, D16′ is about 100-inches to about 130-inches. In certain embodiments, D16′ is about 112-inches to about 118-inches.

As shown in FIG. 6A, tenth distance D10 is a chordwise width of forward wing 106 at its wingtip (i.e., at the end of the outboard end of the wing ends 162, 164). In embodiments, D10 is about 85-inches to about 105-inches. In some embodiments, D10 is about 90-inches to about 100-inches. In certain embodiments, D10 is about 91-inches to about 97-inches. An eleventh distance D11 is a chordwise width of aft wing 110 at its wingtip (i.e., at the end of the outboard end of the wing ends 172, 174). In embodiments, D11 is about 65-inches to about 85-inches. In some embodiments, D11 is about 70-inches to about 80-inches. In certain embodiments, D11 is about 71-inches to about 77-inches.

As shown in FIG. 6B, tenth distance D10′ is a chordwise width of forward wing 206 at its wingtip (i.e., at the end of the outboard end of the wing ends 262, 264). In embodiments, D10′ is about 160-inches to about 180-inches. In some embodiments, D10′ is about 165-inches to about 175-inches. In certain embodiments, D10′ is about 166-inches to about 172-inches. An eleventh distance D11′ is a chordwise width of aft wing 210 at its wingtip (i.e., at the end of the outboard end of the wing ends 272, 274). In embodiments, D11′ is about 120-inches to about 140-inches. In some embodiments, D11′ is about 125-inches to about 135-inches. In certain embodiments, D11′ is about 129-inches to about 135-inches.

A twelfth distance D12, with reference to FIG. 6A, is a lateral (e.g., spanwise) distance of aft wing 110 from wingtip 172 to wingtip 174. In embodiments, D12 is about 500-inches to about 540-inches. In some embodiments, D12 is about 510-inches to about 530-inches. In certain embodiments, D12 is about 516-inches to about 522-inches. The maximum lateral distance D1 between the outermost tips of forward wing ends 162, 164, may match, exceed, or be smaller by some amount to the distance D12. In some embodiments, the distance D1 is closely matched to the distance D12. In other embodiments, the distance D1 exceeds D12 by 10-20 inches. In certain embodiments, the distance D12 may be 100-120 inches shorter than D1.

A twelfth distance D12′, with reference to FIG. 6B, is a lateral (e.g., spanwise) distance of aft wing 210 from wingtip 272 to wingtip 274. In embodiments, D12′ is about 910-inches to about 950-inches. In some embodiments, D12′ is about 920-inches to about 940-inches. In certain embodiments, D12′ is about 929-inches to about 935-inches. The maximum lateral distance D1′ between the outermost tips of forward wing ends 262, 264, may match, exceed, or be smaller by some amount to the distance D12. In some embodiments, the distance D1 is closely matched to the distance D12. In other embodiments, the distance D1′ exceeds D12′ by 10-20 inches. In certain embodiments, the distance D12′ may be 200-300 inches shorter than D1′.

With reference to FIG. 2A, a thirteenth distance D13 is a longitudinal distance between a forward wheel and rear wheel of retractable landing gear 132. In embodiments, D13 is about 175-inches to about 195-inches. In some embodiments, D13 is about 180-inches to about 190-inches. In certain embodiments, D13 is about 182-inches to about 188-inches.

With reference to FIG. 2B, a thirteenth distance D13′ is a longitudinal distance between a forward wheel and rear wheel of retractable landing gear 232. In embodiments, D13′ is about 340-inches to about 380-inches. In some embodiments, D13 is about 350-inches to about 370-inches. In certain embodiments, D13 is about 359-inches to about 365-inches.

As shown in FIG. 6A, a second angle A2 is the angle at which the leading edge of aft wing 110 is swept backward from a lateral axis. In embodiments, A2 is about 10-degrees to about 30-degrees. In some embodiments, A2 is about 15-degrees to about 25-degrees. In certain embodiments, A2 is about 18-degrees to about 22-degrees.

As shown in FIG. 6B, a second angle A2′ is the angle at which the leading edge of aft wing 210 is swept backward from a lateral axis. In embodiments, A2′ is about 10-degrees to about 30-degrees. In some embodiments, A2′ is about 15-degrees to about 25-degrees. In certain embodiments, A2′ is about 18-degrees to about 22-degrees.

FIG. 7A is a front view of a passenger seating arrangement 182 and 184 for STOL aircraft 100. A fourteenth distance D14 is an interior height of the fuselage 108 in the vertical direction at the first seat of the row of seats 182. In embodiments, D14 is about 45-inches to about 65-inches. In some embodiments, D14 is about 50-inches to about 60-inches. In certain embodiments, D14 is about 52-inches to about 558-inches. A fifteenth distance D15 is an interior width of the fuselage 108 in the lateral direction at the row of seats 182. In embodiments, D15 is about 75-inches to about 95-inches. In some embodiments, D15 is about 80-inches to about 90-inches. In certain embodiments, D15 is about 82-inches to about 88-inches.

FIG. 7B is a front view of a passenger seating arrangement 182 and 184 for STOL aircraft 200. A fourteenth distance D14′ is an interior height of the fuselage 208 in the vertical direction at the first seat of the row of seats 282. In embodiments, D14′ is about 83-inches to about 103-inches. In some embodiments, D14′ is about 88-inches to about 98-inches. In certain embodiments, D14′ is about 90-inches to about 96-inches. A fifteenth distance D15′ is an interior width of the fuselage 208 in the lateral direction at the row of seats 182. In embodiments, D15′ is about 140-inches to about 160-inches. In some embodiments, D15′ is about 145-inches to about 155-inches. In certain embodiments, D15′ is about 147-inches to about 153-inches.

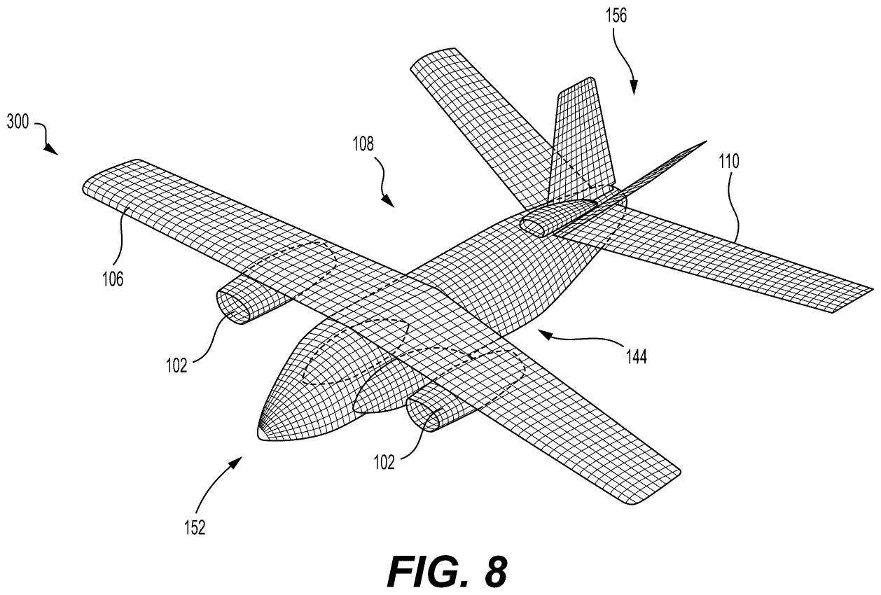

FIG. 8 shows an exemplary STOL aircraft 300 having propulsion engines 102 disposed on the underside of forward wing 106. For example, as shown in FIG. 8, a first propulsion engine 102 is disposed onto the underside of the righthand side and a second propulsion engine 102 is disposed along the lefthand side of forward wing 106. STOL aircraft 200 may have greater or fewer than two engines without departing from the scope hereof. Due to the presence of two individual engines, each propulsion engine 102 is smaller compared with the propulsion engine 102 with STOL aircraft 100. The presence of multiple individual engines allows for a more distributed propulsion arrangement which may be used to provide improved propulsive performance.

In operation, STOL aircraft 100, 200, and 300 are configured for operating with a thrust to weight ratio of about 0.5 lb/lb, in embodiments. STOL aircraft 100/200/300 are configured for operating with a wing loading of about 20-lb/ft² to about 35-lb/ft². In embodiments, STOL aircraft 100/200/300 are configured to have a takeoff distance of about 200-ft to about 800-ft. In some embodiments, the takeoff distance is about 400-ft to about 600-ft. The short takeoff distance of STOL aircraft 100/200/300 may allow them to take off from airfields that are also used by vertical-takeoff and landing (VTOL) aircraft. In embodiments, the tandem wing configuration of STOL aircraft 100/200/300 may allow for lifting to occur with less wing span, reducing the overall vehicle footprint for operations in confined or austere environments. The turboshaft compressors 124/224 may increase the lifting capability of the airfoils and enhance the control authority of the flight control surfaces. This allows for the STOL aircraft 100/200/300 to have lower stall speeds and hence shorter runway requirements. In embodiments, STOL aircraft 100/200 are configured to have a maximum takeoff weight of about 12,000-lbs to about 15,000-lbs. In some embodiments, the maximum takeoff weight is about 55,000-lbs to about 95,000-lbs. Additionally, airspeed of STOL aircraft 100/200/300, in embodiments, is less than 420-knots, which provides a range of about 1,600 nautical miles (nm). Depending on the payload onboard STOL aircraft 100/200/300, the range may be from 500-nm to 2,000-nm. In some embodiments, the range is between 550-nm and 650-nm with maximum payload.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. An aircraft configured for short-takeoff and landing, the aircraft comprising:
a tandem wing configuration having a forward wing on a top side of a fuselage and an aft wing on the top side of the fuselage;
wherein the forward wing comprises a downward anhedral angle only such that a wing tip of the forward wing is lower than the top side of the fuselage, and wherein the forward wing comprises a straight unswept leading edge and a tapered trailing edge;
wherein the aft wing comprises an upward dihedral angle and a swept leading edge;
a fixed-orientation propulsion engine that remains in a forward-facing position;
a landing gear, wherein the landing gear is retractable and includes forward wheels and rear wheels; and
an unobstructed cargo door located on a side of the fuselage, wherein the unobstructed cargo door is configured for receiving cargo into a cargo area of the fuselage without being obstructed by the forward wing by being located aft of the forward wing, and without being obstructed by the rear wheels by being located forward of the rear wheels.

2. The aircraft of claim 1, comprising at least one row of seats located behind a cockpit and in front of the cargo area.

3-4. (canceled)

5. The aircraft of claim 1, wherein a longitudinal distance between the forward wheel and the rear wheel of the landing gear is 175-inches to 380-inches.

6. The aircraft of claim 1, wherein the fixed-orientation propulsion engine is configured to provide a thrust to weight ratio of 0.5-lb/lb.

7. The aircraft of claim 1, wherein the tandem wing configuration is configured to provide a wing loading of 20-lb/ft² to 35-lb/ft².

8. The aircraft of claim 1, wherein the fixed-orientation propulsion engine is configured to provide a takeoff distance of 200-ft to 800-ft.

9. The aircraft of claim 1, wherein the aircraft is configured to have a maximum takeoff weight of 12,000-lbs to 95,000-lbs.

10. The aircraft of claim 1, wherein the aircraft is configured to have a maximum airspeed of 420-knots.

11. The aircraft of claim 1, wherein the aircraft is configured to have a maximum range of 500-nm to 2,000-nm nautical miles.

12. The aircraft of claim 1, wherein the tandem wing configuration comprises a distance between outermost wing ends of the forward wing is of 640-inches to 1215-inches, and a distance between outermost wing ends of the aft wing of 500-inches to 950-inches.

13. (canceled)

14. The aircraft of claim 1, comprising a nose section at a forward end of the fuselage and a tail section at an aft end of the fuselage, wherein a maximum longitudinal distance from a forwardmost tip of the nose section to an aftmost point of the tail section is 400-inches to 980-inches.

15. The aircraft of claim 14, wherein an angle between a bottom of the landing gear and the aftmost point of the tail section is 10-degrees to 30-degrees.

16. The aircraft of claim 1, wherein an interior height of the fuselage at a row of seats is 45-inches to 103-inches.

17. The aircraft of claim 1, wherein an interior width of the fuselage at a row of seats is 75-inches to 160-inches.

18. The aircraft of claim 1, wherein an exterior width of the fuselage is 70-inches to 170 inches.

19. The aircraft of claim 1, wherein an exterior height of the fuselage is 50-inches to 140-inches.

20. The aircraft of claim 1, wherein a radius of a fan blade of the fixed-orientation propulsion engine is 6-inches to 70-inches.

21. The aircraft of claim 1, wherein the fixed-orientation propulsion engine comprises a double jet propulsion engine mounted within a tail cone of the fuselage and beneath the aft wing.

22. The aircraft of claim 1, further comprising at least one air intake disposed on a top portion of the fuselage forward of the aft wing.

23. The aircraft of claim 1, further comprising a turboshaft compressor configured to provide compressed air for active flow control over control surfaces and lifting surfaces.

24. The aircraft of claim 23, further comprising an air intake upstream of the turboshaft compressor, wherein the air intake is configured to be actuated during flight for modulating an amount of air flow entering the turboshaft compressor.

25. The aircraft of claim 1, wherein the cargo area is configured for receiving pallets of cargo.
